(19) United States
(12) Patent Application Publication
(10) Pub. No.: US 2019/0155936 A1
(43) Pub. Date: May 23, 2019

(54) Replication Catch-up Strategy

(71) Applicant: Rubrik, Inc., Palo Alto, CA (US)

(72) Inventors: Cong Du, San Jose, CA (US); Mudit Malpani, Mountain View, CA (US)

(73) Assignee: Rubrik, Inc., Palo Alto, CA (US)

(21) Appl. No.: 15/821,715

(22) Filed: Nov. 22, 2017

(51) Int. Cl. G06F 17/30; G06F 9/455

(52) U.S. Cl. CPC G06F 17/30575; G06F 2201/84; G06F 9/45558

(57) ABSTRACT

The disclosed technology teaches catch-up replication, replicating to a target machine, a set of snapshots including replicated snapshots and un-replicated snapshots, stored in sequence at a source machine, that backup one or more virtual machines. The source machine receives a criterion for an un-replicated window, which corresponds to at least one un-replicated snapshot after a last replicated snapshot in the sequence; and by comparing the un-replicated window determined to a previously determined criterion for the un-replicated window, and based upon the comparing: when the un-replicated window is greater than the received criterion, replicating a snapshot in the sequence equal to or greater than a configured set-point position of the un-replicated window, thereby skipping some earlier un-replicated snapshots at positions prior to the configured set-point position, and marking the replicated snapshot in the sequence; and otherwise replicating an un-replicated snapshot positioned after the last replicated snapshot in the sequence.

### RELATED APPLICATIONS

This application is related to U.S. patent application Ser. No. 15/800,020 entitled “VIRTUAL MACHINE LINKING” filed 31 Oct. 2017 (Atty. Docket No. RUBK 1004-1). The related application is hereby incorporated by reference herein for all purposes.

This application is also related to U.S. Patent Application No. US20160124977 A1 entitled “Data Management System,” by Arvind Jain, et al., filed Feb. 20, 2015, which is incorporated by reference herein.

This application is also related to U.S. Provisional Patent Application No. 62/570,436 entitled “Incremental File System Backup Using a Pseudo-Virtual Disk,” by Soham Mazumdar, filed Oct. 10, 2017, which is incorporated by reference herein.

### BACKGROUND

A virtual machine (VM) is an emulation of a computer system. Virtual machines are based on computer architectures and provide the functionality of a physical computer. System virtual machines, also referred to as full virtualization VMs, provide a substitute for a real machine—providing functionality needed to execute entire operating systems. In contrast, process virtual machines are designed to execute computer programs in a platform-independent environment.

VMs have extensive data security requirements and typically need to be available continuously to deliver services to customers. For disaster recovery and avoidance, service providers that utilize VMs need to avoid data corruption and service lapses to customers, for services delivered both by external machines and via the cloud.

Virtual machine replication (VM replication) is a type of VM protection that takes a copy, also referred to as a snapshot, of the VM as it is at the present time and copies it to another VM. Users of VMs need to be able to replicate their VMs to protect their data locally within a single site and to isolate data between two sites.

VM backup and replication are essential parts of a data protection plan. Backup and replication are both necessary to keep a source virtual machine's data so it can be restored on demand. VM backup and replication have different objectives.

VM backups are intended to store the VM data for as long as deemed necessary to make it feasible to go back in time and restore what was lost. As the main objective of backups is long-term data storage, various data reduction techniques are typically used by backup software to reduce the backup size and fit the data into the smallest amount of disk space possible. This includes data compression, skipping unnecessary swap data and data deduplication, which removes the duplicate blocks of data and replaces them with references to the existing ones. Because VM backups are compressed and deduplicated to save storage space, they no longer look like VMs and are often stored in a special format that a backup software app can understand. Because a VM backup is just a set of files, the backup repository is a folder, which can be located anywhere: on a dedicated server, storage area network (SAN) or in a cloud.

Modern backup software allows for various types of recovery from backups: professionals can near-instantly restore individual files, application objects, or even entire VMs directly from compressed and deduplicated backups, without running the full VM restore process first. Backups of virtual infrastructure are critical but when something happens to multiple virtual machines or perhaps an entire site, it becomes necessary to restore the data either back to the original virtual machine or to recreate the entire virtual machine from that backup data.

VM replication creates an exact copy of the source VM and puts the copy on target storage, to circumvent the time required to bring data or services back online in the event of a site-wide failure or severely impaired primary site, whether it be hardware failure, a natural disaster, malware, or self-inflicted impairment. VM replicas, the result of replication, are usable to restore the VMs as soon as possible. Enterprise businesses also require the ability to migrate whole data centers, which can be accomplished via VM replication, making an exact copy of multiple virtual machines.

A hypervisor is a virtual machine monitor that uses native execution to share and manage hardware, allowing for multiple environments which are isolated from one another, yet exist on the same physical machine hardware. For example, third-party service VMware© utilizes ESXi architecture as a bare-metal hypervisor that installs directly onto a physical server, enabling it to be partitioned into multiple logical servers referred to as VMs. In one example, VMware© vCenter, a centralized management application for managing VMs and ESXi hosts centrally, identifies a VM by an ID that is assigned by the resource manager when the virtual machine is registered.

In existing systems, if a replication target has multiple snapshots to replicate, the latest snapshot is chosen and replicated, and earlier snapshots are not replicated, which enables the replication target to catch up with the source quickly and therefore be compliant with the service level agreement (SLA) thereafter, but by skipping a few snapshots, the terms of the SLA can get violated.

An opportunity arises to catch up on backlogs of replication requests while maintaining compliance with the SLA, replicating to a replication target at a target machine and at a current replication set-point, a set of snapshots including replicated snapshots and un-replicated snapshots, stored in time sequence at a source machine, to create a copy of multiple virtual machines.

### SUMMARY

The disclosed technology teaches a method of replicating to a replication target at a target machine and at a current replication set-point, a set of snapshots including replicated snapshots and un-replicated snapshots, stored in sequence at a source machine, that backup one or more virtual machines. The source machine receives a criterion for an un-replicated window, which indicates a difference in the sequence between the current replication set-point and a last replication set-point. The last replication set-point corresponds to at least one un-replicated snapshot after a last replicated snapshot in the sequence. The source machine compares the un-replicated window determined to a previously determined criterion for the un-replicated window, and based upon the comparing, when the un-replicated window is greater than the received criterion for an un-replicated window, replicates a snapshot in the sequence equal to or greater than a configured set-point position of the un-replicated window in the sequence, thereby skipping some earlier un-replicated snapshots at positions prior to the configured set-point position, and marking the replicated snapshot in the sequence; and replicating an un-replicated snapshot positioned after the last replicated snapshot in the sequence, otherwise.

Particular aspects of the technology disclosed are described in the claims, specification and drawings.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 shows an environment for replicating a set of snapshots, stored in sequence at a source machine, that backup one or more virtual machines.

FIG. 2 shows an example timeline for VM replication with multiple full snapshots.

FIG. 3 illustrates an example message flow between a source server cluster and a target server cluster,

FIG. 4 shows an example dialog box within the UI for the Rubrik platform for customizing a VM SLA.

FIG. 5 shows an example UI screen for viewing the snapshots for a selected VM, by calendar month.

FIG. 6 shows an example UI screen for viewing multiple snapshots for a day that has been selected on the calendar shown in FIG. 5.

FIG. 7 shows a replication report, with the source cluster snapshots represented by the dots on dates on the left side of the screen, and target cluster snapshots represented by the dots on the right side of the screen.

FIG. 8 shows a user interface dashboard of a system report that includes local storage by SLA domain, local storage growth by SLA domain, and a list of VM objects by name, object type, SLA domain and location.

FIG. 9 is a simplified block diagram of a system for replicating a set of snapshots, stored in sequence at a source machine, that backup one or more virtual machines.

### DETAILED DESCRIPTION

The following description of the disclosure will typically be with reference to specific embodiments and methods. It is to be understood that there is no intention to limit the disclosure to the specifically disclosed embodiments and methods, but that the disclosure may be practiced using other features, elements, methods and embodiments. Preferred embodiments are described to illustrate the present disclosure, not to limit its scope. Those of ordinary skill in the art will recognize a variety of equivalent variations on the description that follows. Like elements in various embodiments are commonly referred to with like reference numerals.

Modern companies need to be able to continuously deliver services to customers and must safeguard the data of their customers. For disaster recovery and avoidance, service providers that utilize VMs need to avoid data corruption and service lapses to customers by replicating VMs running on production servers to data recovery servers.

In organizations with multiple data centers, it is common to have regular failover tests across data centers to ensure that the company is prepared for disaster recovery. In some cases the company replicates between data centers for data recovery and do a complete failover between data centers every six 6 months. That is, data center roles are reversed every six months between production servers and data recovery servers.

In some physical environments, replication can be delayed—by slow network speeds, poor network connections, networks that are stopped for some period of time, and by nodes down for service or due to other causes. The lag in replications can exist for days or weeks. Meanwhile the customer wants all of their VM snapshots to be replicated.

Before requesting replication, a replication engine must determine which snapshot to replicate. In existing systems, if a replication target has a backlog of multiple snapshots to replicate, the latest, most-recent-in-time snapshot is chosen and replicated, and earlier snapshots are not replicated. While this historical approach enables the replication target to catch up with the source quickly and therefore become compliant with the VM's SLA going forward, when fewer snapshots get replicated than are specified in the SLA, the result is that the terms of the SLA are violated due to skipping some of the snapshots.

The disclosed technology makes it possible to catch-up with source snapshot replication as soon as possible, while capturing as many earlier snapshots as possible, to be compliant with the SLA, described infra, for the VMs. By adjusting the snapshot choice for replication heuristically, based on the incoming rate of snapshots and the snapshot replication rate, a set of snapshots including replicated snapshots and un-replicated snapshots, stored in time sequence at a source machine, creates a copy of multiple virtual machines. The snapshots are chosen for replicating to a replication target at a target machine and at a current replication set-point. An environment for replicating the most recent snapshot as soon as possible while avoiding losing snapshot history is described next.

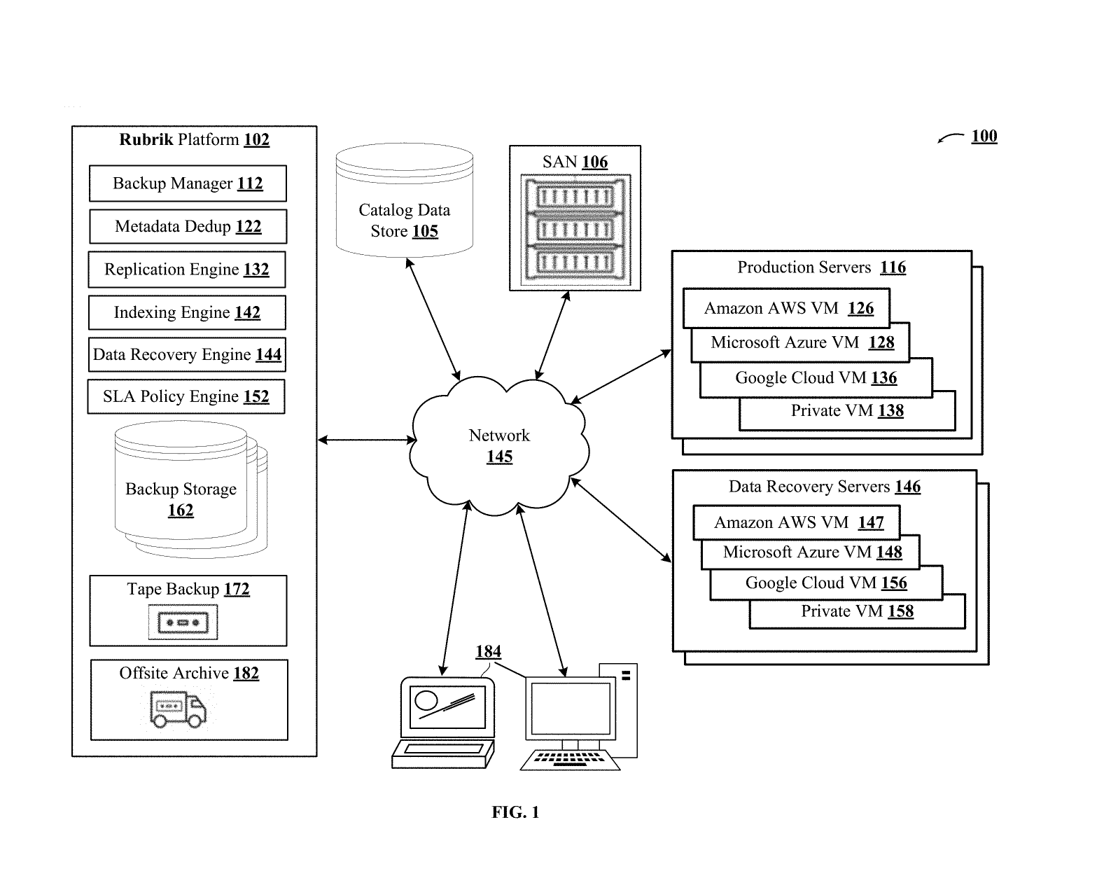

FIG. 1 shows an environment 100 for replicating to a replication target at a target machine, a set of snapshots that create a copy of multiple virtual machines. Rubrik platform 102 includes backup manager 112 for unifying backup services, metadata dedup 122 for deduplicating metadata associated with the VMs, replication engine 132 for managing replicating of the VMs, indexing engine 142 for listing VMs for tracking, and data recovery engine 144 for copy data management.

Also included in environment 100, SLA policy engine 152 includes intelligence to determine when to replicate to meet terms of service level agreements (SLA); and backup storage 162, tape backup 172 and offsite archive 182 are available for securely storing and archiving identified backup data across the data center and cloud. In one example implementation of platform 102, VMware© vCenter, a centralized management application for managing VMs and ESXi hosts centrally, identifies a VM by an ID that is assigned by the resource manager when the virtual machine is registered and tracked by indexing engine 142. VMware© vSphere cloud computing virtualization platform client accesses the vCenter server and assigns a managed object reference ID (MOID) when a VM is registered to the vCenter. In another example implementation, platform 102 can utilize a different hypervisor, such as System Center Virtual Machine Manager (SCVMM) for virtual machine management, and in a third example implementation, Nutanix hyper-converged appliances can be utilized in Rubrik platform 102 for identifying historical snapshots for VMs.

Environment 100 also includes catalog data store 105, which is kept updated with deduplicated data via metadata dedup 122 in platform 102; and SAN 106 (storage area network)—a repository which can be located locally on a dedicated server or in the cloud, for storing VM backup folders. Additionally, environment 100 includes production servers 116 with multiple VMs, which can include Amazon AWS VM 126, Microsoft Azure VM 128, Google Cloud VM 136 and private VM 138. Multiple VMs of each type can typically run on a single production server and multiple production servers can be managed via platform 102. Further included in environment 100 are data recovery servers 146 for multiple VMs, which can include Amazon AWS VM 147, Microsoft Azure VM 148, Google Cloud VM 156 and private VM 158 platforms that upload snapshots. In some implementations, data recovery servers 146 are in the cloud and in other cases data recovery servers 146 are on premise hardware. The disclosed VM linking technology links the VMs as described infra. Snappable refers to a class of objects that can be snapshotted, also referred to as replicated, and includes VMs and physical machines. When the metadata of a VM gets uploaded to the cloud, additional info such as the ID of the snappable group to which the VM belongs can get added. In the context of the disclosed technology, the terms VM group and snapshot group can be used interchangeably. Depending on the use case, metadata can be stored with the VM group. The metadata will depend on the VM type and can be represented as a serialized JSON object. In one example instance, additional metadata can include a map from a new binary large object (blob) store group ID to an old blob store group Id, in order to preserve a single chain to optimize storage utilization.

User computing device 184, also included in environment 100, provides an interface for managing platform 102 for administering services, including backup, instant recovery, replication, search, analytics, archival, compliance, and copy data management across the data center and cloud. In some implementations, user computing devices 184 can be a personal computer, laptop computer, tablet computer, smartphone, personal digital assistant (PDA), digital image capture devices, and the like.

Modules can be communicably coupled via a different network connection. For example, platform 102 can be coupled via the network 145 (e.g., the Internet) with production servers 116 coupled to a direct network link, and can additionally be coupled via a direct link to data recovery servers 146. In some implementations, user computing device 184 may be connected via a WiFi hotspot.

In some implementations, network(s) 145 can be any one or any combination of Local Area Network (LAN), Wide Area Network (WAN), WiFi, WiMAX, telephone network, wireless network, point-to-point network, star network, token ring network, hub network, peer-to-peer connections like Bluetooth, Near Field Communication (NFC), Z-Wave, ZigBee, or other appropriate configuration of data networks, including the Internet.

In some implementations, datastores can store information from one or more tenants into tables of a common database image to form an on-demand database service (ODDS), which can be implemented in many ways, such as a multi-tenant database system (MTDS). A database image can include one or more database objects. In other implementations, the databases can be relational database management systems (RDBMSs), object oriented database management systems (OODBMSs), distributed file systems (DFS), no-schema database, or any other data storing systems or computing devices.

In other implementations, environment 100 may not have the same elements as those listed above and/or may have other/different elements instead of, or in addition to, those listed above.

The technology disclosed can be implemented in the context of any computer-implemented system including a database system, a multi-tenant environment, or the like. Moreover, this technology can be implemented using two or more separate and distinct computer-implemented systems that cooperate and communicate with one another. This technology can be implemented in numerous ways, including as a process, a method, an apparatus, a system, a device, a computer readable medium such as a computer readable storage medium that stores computer readable instructions or computer program code, or as a computer program product comprising a computer usable medium having a computer readable program code embodied therein.

Snapshots are chosen for replication to a replication target at a target machine and at a specific replication set-point. The current set-point is the time of the most recent replication and the last replication set-point is a time when the last replication had taken place. The difference in time between the last replication set-point and the current replication set-point can be defined as the lag window T_{W}.

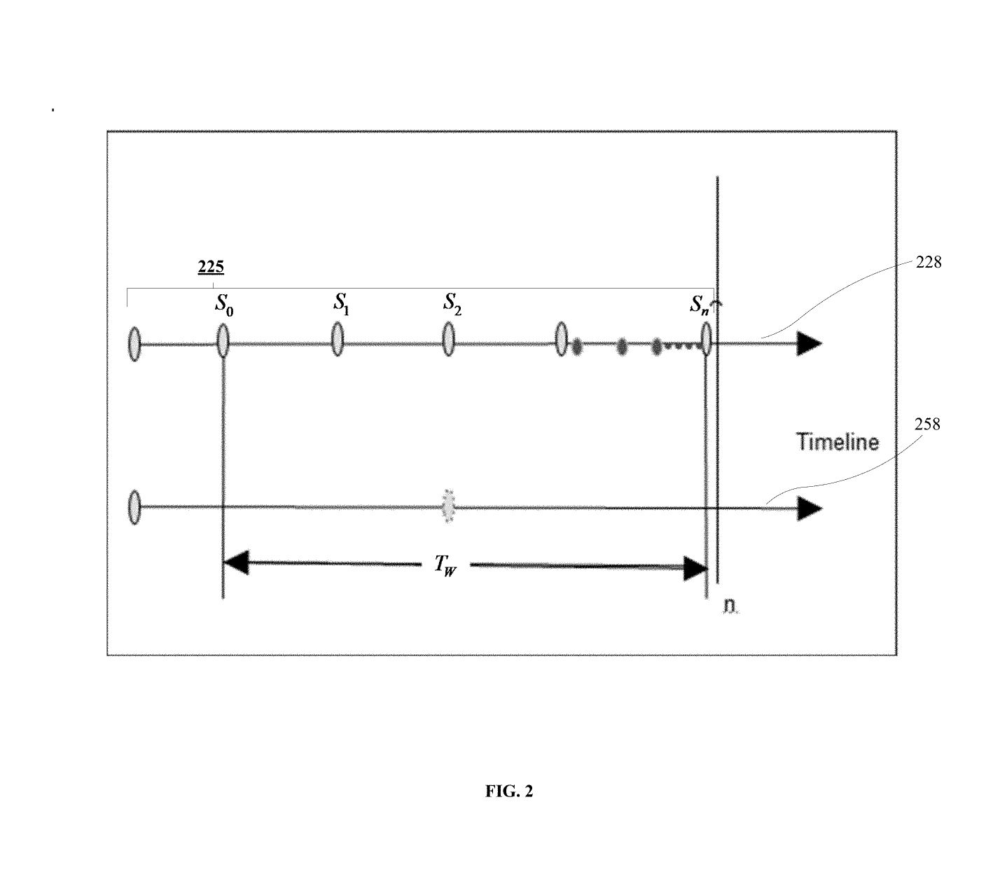

FIG. 2 shows a timeline 228 for VM replication with full snapshots S₀, S₁, S₂, . . . Sₙ 225. The difference in time between the first, oldest-in-time, available snapshot to be replicated and the last, most-recent-in-time, available snapshot to be replicated can be defined as the lag window T_{W}. Timeline 258 shows lag window T_{W} for which replication needs to be completed. Before starting replication, the lag window T_{W} is initialized to zero. The disclosed technology includes a heuristic for choosing which snapshot to replicate, which utilizes the value of T_{W}. Each time the target server 328 is ready to replicate another snapshot, the current value of T_{W} gets calculated and the value is used to select which snapshot to replicate. The value of T_{W} is updated and kept with the chosen snapshot replication job.

In one case, if the current value of T_{W} is larger than the previously calculated value of T_{W}, then snapshots earlier than a configured set-point position get skipped, and the first snapshot occurring later in time than the configured set-point position of lag window T_{W} gets selected for replication. For example, if the configured set-point position is set to fifty percent, then when the current calculated value of T_{W} is larger than the previously calculated value T_{W}, snapshots within the first half of the window get skipped, and the first snapshot in the latter half of lag window T_{W} gets selected for replication. That is,

If T_{W} increases:

Choice = FirstSnapshotOnOrAfter(SnapshotDate( S₀ ) + T_{W} /2) // S₂

Else

Choice = FirstSnapshotOnOrAfter(SnapshotDate( S₀ )) // S₀

In another use case, if the configured set-point position, also referred to as the “skip fraction”, is set to sixty percent, the selection will be the first snapshot in the latter forty percent of lag window T_{W}.

For the case in which when the current calculated value of T_{W} is smaller than the previously calculated value of T_{W}, the system is catching up with snapshot replication, so replicates the earliest un-replicated snapshot that is more recent than the last replication. That is, no snapshots get skipped.

Lag window T_{W} is a value used by all instances of a job, so is stored in the static job config data structure. An example of the job config data structure, included in the example heuristic algorithm, is listed next. It is typically stored in a distributed and decentralized in-memory database designed that can manage very large amounts of structured data spread out across the world. For this example implementation, the time period, in milliseconds, is stored in lastCatchupWindow. In the example, the value of lastCatchupWindow is 55 hours.

{

“snappableId”: “00000000-3ee2-4c27-000-ad87a348dce2-vm-263”,
“snappableType”: “VmwareVirtualMachine”,
“snappableName”: “some-vm”,
“sourceClusterId”: “00000000-3a68-4e2e-8c3e-000000000000”,
“remoteClusterConfig”: ....,
“lastCatchupWindow”: 198000000
...}

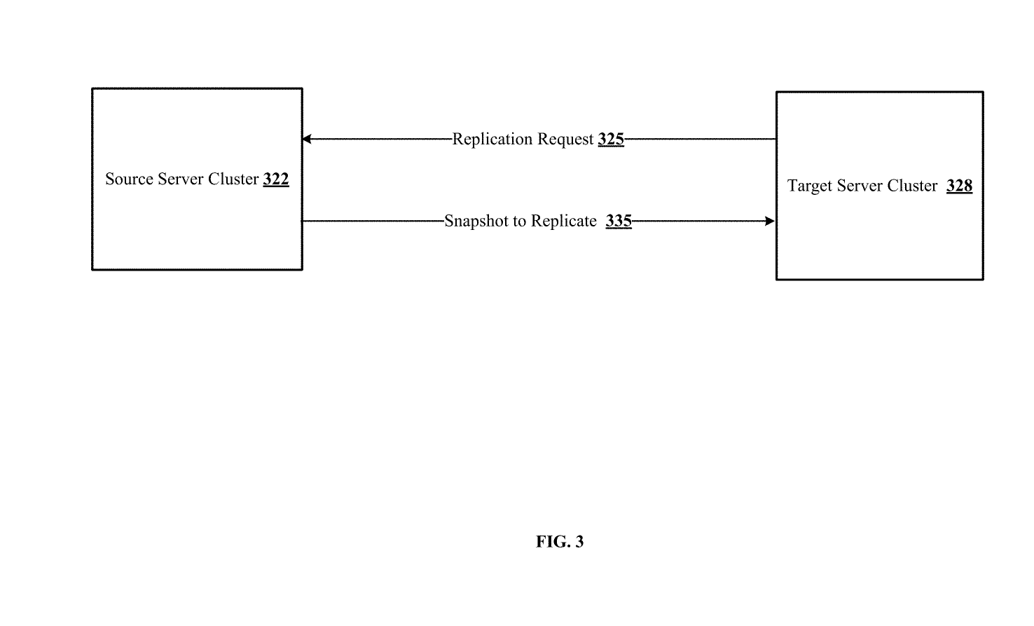

FIG. 3 shows an example message flow between source server cluster 322 and target server cluster 328. Replication request 325 triggers comparing the un-replicated window to the received criterion for the un-replicated window, and based upon the comparing when the un-replicated window is greater than the received criterion for an un-replicated window, replicating a snapshot 335 in the sequence equal to or greater than a configured set-point position of the un-replicated window in the sequence, thereby skipping some earlier un-replicated snapshots at positions prior to the configured set-point position, and marking the replicated snapshot in the sequence; and otherwise replicating an un-replicated snapshot positioned after the last replicated snapshot in the sequence.

On source server cluster 322, once a snapshot is replicated, it can be marked as such in a replication state. This is usable for determining whether a snapshot has been replicated and to determine which snapshots are valid candidates for replication. In replication request 325, target server cluster 328 also optionally provides the last replicated snapshot timestamp, as the time point from which the replication target is expecting to receive snapshots. This can be used by source server cluster 322 in determining the starting point in the case in which a newly upgraded source cluster does not know whether snapshots have been replicated in the previous version.

The time span of snapshots replicated in the last successful replication, referred to as the thrift endpoint data structure, is utilized by the disclosed catch-up replication technology. The two structures listed are for the request and for the response.

struct NextSnapshotInfoRequest {
1: replication_common.RequestContext context
2: string snappable_id
3: string snappable_type
4: optional i64 last_catchup_window
5: optional i64
}
struct NextSnapshotInfoResponse {
1: common.Status status
2: list<metadata.SnapshotInfo> value
3: optional i64 catchup_window
}

The source server cluster 322 heuristic algorithm is summarized next. The first step is to get only snapshots with a more recent date than the date of the last replicated snapshot on the target, and then sorting the snapshots by date.

nextSnapshotInfo(request: NextSnapshotInfoRequest){

check(request)
version = request.context.version
if (version >= VersionWithCatchupWindow) {

allSnapshots =
getAllSnapshotsForSnappable(request.snappable_id)

candidates =

allSnapshots

.filter(

_.date >
request.last_replicated_snapshot_timestamp_ms)

.sort(_.date)

if (candidates.size == 0) {

return new NextSnapshotInfoResponse(

Status.OK,
List(getLatestSnapshot(allSnapshots)

).setCatch_up_window(0)

} else {

newCatchupWindow =

snapshots.last.date − snapshots.first.date

if ( request.last_catchup_window == 0 ∥

newCatchupWindow <=
MinimumReplicationAllowedLag ∥
request.last_catchup_window >=
newCatchupWindow) {

// up to date, choose next snapshot
snapshot = candidates.first

} else {

startTime =

candidates.first.date + newCatchupWindow * SkipFraction

snapshot = getFirstSnapshotAfter(candidates, startTime)

}
return new NextSnapshotInfoResponse(

Status.OK,
List(snapshot.info)

).setCatch_up_window(newCatchupWindow)

}

} else {
// old format
allSnapshots = getAllSnapshotsForSnappable(request.snappable_id)
Snapshot = getLatestSnapshots(allSnapshots)
return New NextSnapshotInfoResponse(

Status.OK,
List(snapshot.info))

} // else

}

Target server cluster 328 writes the last snapshot window to job-config, as summarized next.

snapshots = getAllSnapshotsForSnappable(snappableId)
snapshotDates = getAllDates(snapshots)
version = GetSourceClusterVersion( )
request = new NextSnapshotInfoRequest(

Context,
snapshotId,
snapshotType)

if (version >= VersionWithCatchupWindow) {

request.setLast_catchup_window(getCatchupWindow(jobConfig))

Request

.setLast_replicated_snapshot_timestamp_ms(

max(snapshotDates))

}
response = nextSnapshotInfo(request)
if (response.isSetLast_replicated_snapshot_timestamp_ms) {

// write last snapshot window to job-config
// if this is the first snapshot, discard the snapshot window
// so that we can replicate the second snapshot.
if (snapshot.size == 0)

jobConfig.lastCatchUpWindow = 0

else

jobConfig.lastCatchUpWindow =
response.lastCatchupWindow

jobConfig.persist( )

}
// Sanity check to see if we have a valid snapshot to replicate
if check(response.value){

snapshotInfo = response.value[0]
replicate(snapshotInfo)

}

In one example use of the disclosed heuristics, target server cluster 328 requests to replicate the next snapshot for “a-vm”, receives 691200000 (8 days) from last_catchup_window in job config, and the date the latest replicated snapshot was taken for “a_vm” as “Sun Oct 01 00:00:00 PDT 2017”—via the “NextSnapshotInfoRequest” data structure, described earlier.

struct NextSnapshotInfoRequest {

1: ...
2: “a_vm”, // snappable_id
3: “VmwareVirtualMachine”, //snappable_type
4: 691200000, // 8 days - last_catchup_window
5: 1506841200000 // Sun Oct 01 00:00:00 PDT 2017

}

Continuing with the example, source service cluster 322 receives replication request 325 and determines that the time span for the snapshots with date later than “Sun Oct 01 00:00:00 PDT 2017” is from “Sun Oct 02 03:00:00 PDT 2017” to “Sun Oct 09 03:00:00 PDT 2017” which is 7 days, which is shorter than 8 days, so selects the snapshot dated “Sun Oct 02 03:00:00 PDT 2017” as the next snapshot to replicate 335 and sends the following response:

struct NextSnapshotInfoResponse {
1: Status(“OK”)
2: List(“a snapshotId dated at Sun Oct 02 03:00:00 PDT 2017”)
3: 604800000 // 7 days
}

Target service cluster 328 stores last_catchup_window=604800000 (7 days) into job config, for use in the next request, and replicates the snapshot's “a snapshotId dated Sun Oct 02 03:00:00 PDT 2017”.

For some implementations of the disclosed technology an explicit check is executed of the version of the source and target cluster software. In the case in which source server cluster 322 does not support the disclosed heuristic described earlier for determining which snapshot to replicate, the following algorithm can be used on source server cluster 322 for selecting the next snapshot to replicate.

nextSnapshotInfo(request: NextSnapshotInfoRequest){

version = request.context.version
check(request)
snapshots = getAllSnapshotsForSnappable(request.snappable_id)
Snapshot = getLatestSnapshots(snapshots)
New NextSnapshotInfoResponse(

Status.OK,
List(snapshot.info)

)

}

The heuristic described earlier for catch-up replication is usable on target server cluster 328 for determining which snapshot to replicate.

In the case in which an explicit check of the version of the source and target clusters reveals that source server cluster 322 utilizes a version that supports the heuristic described earlier for catch-up replication, then source server cluster 322 utilizes that heuristic algorithm. If target server cluster 328 does not support the heuristic described earlier for determining which snapshot to replicate, the following algorithm can be used on target server cluster 328 for selecting the next snapshot to replicate.

request = new NextSnapshotInfoRequest(

Context,
snappableId,
snapshotType)

response = nextSnapshotInfo(request)
snapshotInfo = response.value[0]
// Sanity check to see if we can replicate this snapshot
if check(snapshotInfo){

replicate(snapshotInfo)

}

In summary, for some implementations of the disclosed technology an explicit check is executed to determine whether the version of software running on the source cluster and the version running on the target cluster support the disclosed heuristic for replication catch-up, before determining which snapshot request to utilize for replication.

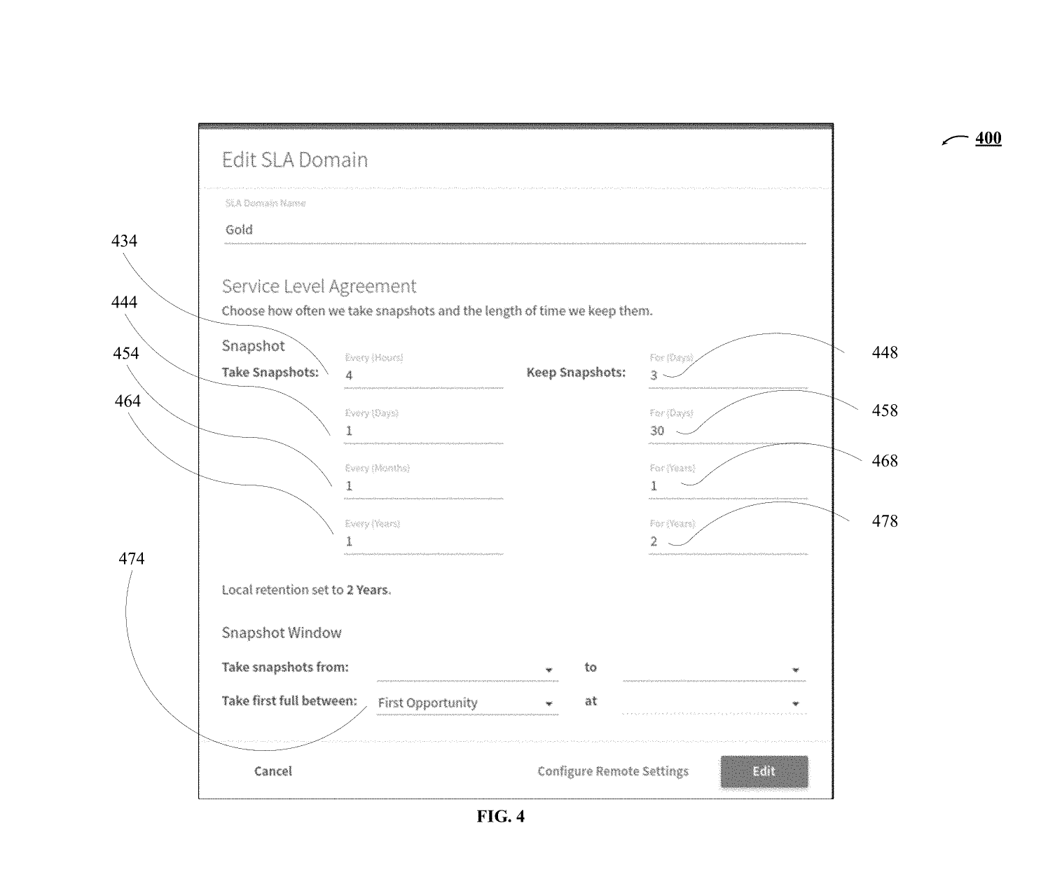

FIG. 4 shows an example “Edit SLA Domain” dialog box 400 within the user interface for Rubrik platform 102 for customizing a VM SLA—an official commitment that prevails between service provider and client, with specific aspects of the service, including how often to take VM snapshots and how long to keep the snapshots, as agreed between the service provider and the service user. In the example shown, a VM snapshot is to be taken once every four hours 434, once every day 444, once every month 454 and once every year 464. The four-hour snapshots are to be kept for three days 448, the daily snapshots are to be retained for thirty days 458, the monthly snapshots are kept for one month 468 and the yearly snapshots are to be retained for two years 478. Note that the first full snapshot is to be taken at the first opportunity 474.

The configured SLA gets propagated to the linked VM. SLAs are tracked per VM object with one object per MOID. When a new VM and thereby a new MOID is linked to an existing set of VMs, the SLA of the active newest VM object in the snappable group is assigned to the new VM object, which becomes the new active VM in the group. In one implementation, if the old VM was inheriting SLA from higher-level objects from its hierarchy such as the host, a folder or vCenter, the new VM object will forget that SLA and go back to inheriting mode and will inherit SLA from the higher-level objects in its new hierarchy. If the higher-level objects in its new hierarchy do not have an SLA assigned to them, the new VM will show no SLA. If an SLA is assigned to one of the higher-level objects, the new VM will pick it up. Different SLA propagation scenarios can be implemented for other use cases. In one case, if the customer wants to preserve inherited SLAs of the VMs in the new vCenter, they may choose to bulk-assign direct SLAs to the VMs via the UI before migration of their VMs.

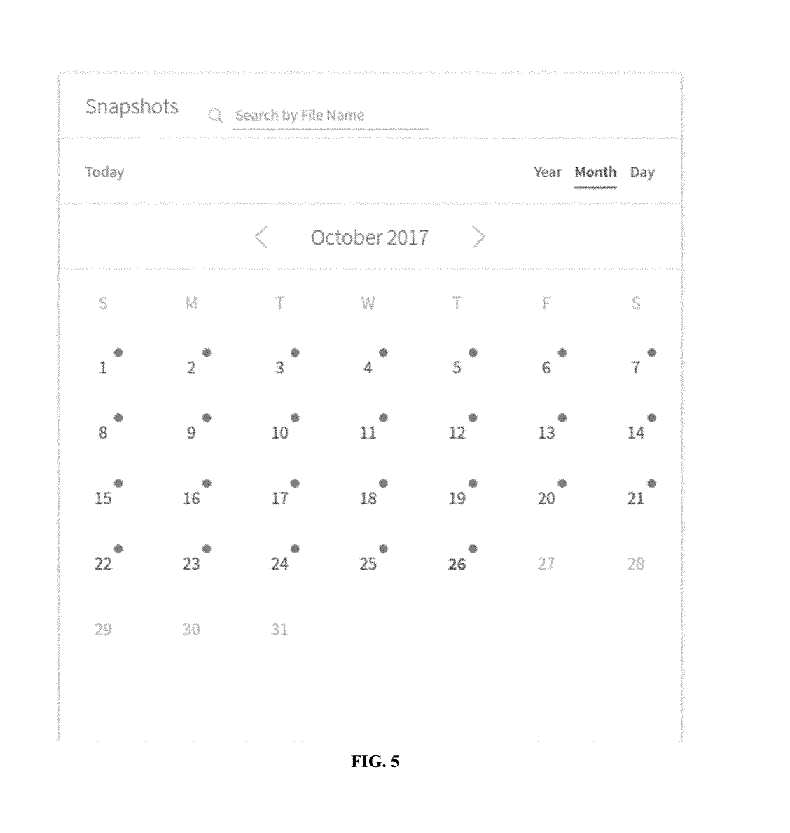

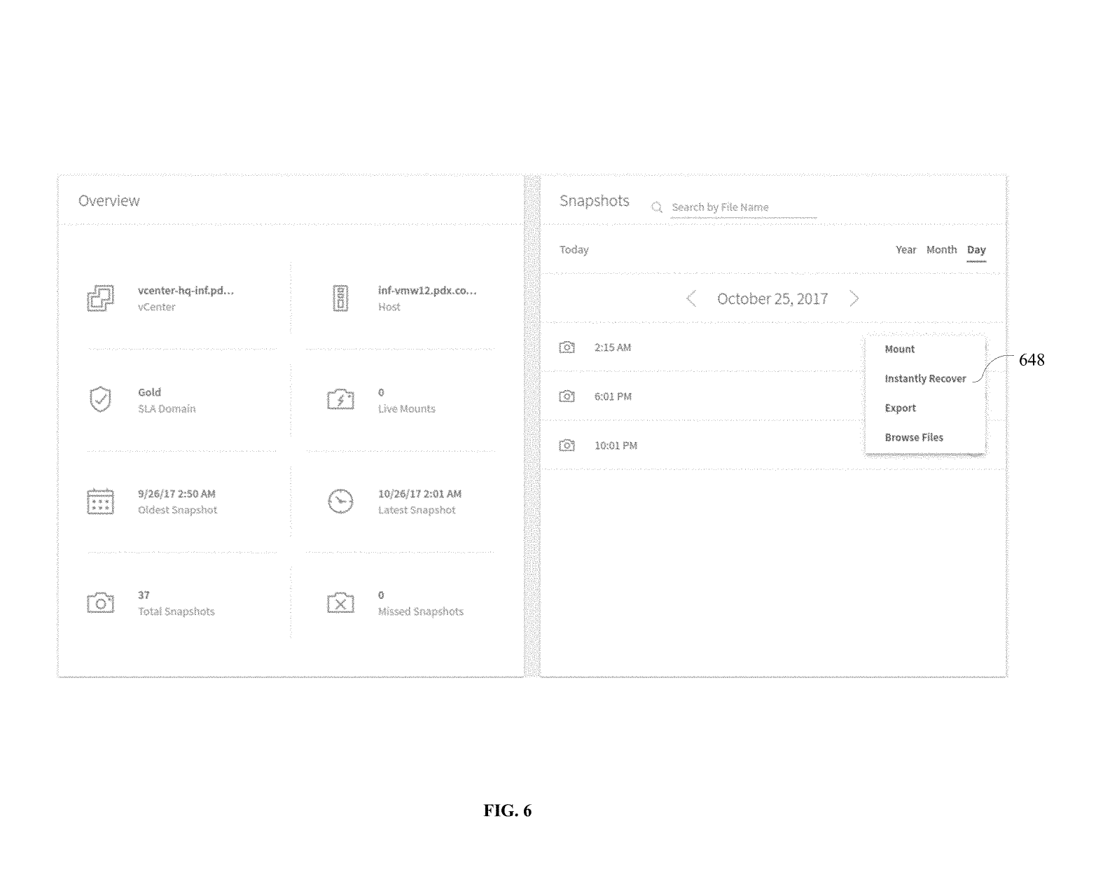

FIG. 5 shows an example UI screen of platform 102 for viewing the snapshots for a selected VM, by calendar month, with a dot on every date that has a stored snapshot. FIG. 6 shows an example UI screen for viewing multiple snapshots for a day that has been selected on the calendar shown in FIG. 5—Oct. 25, 2017 in this example.

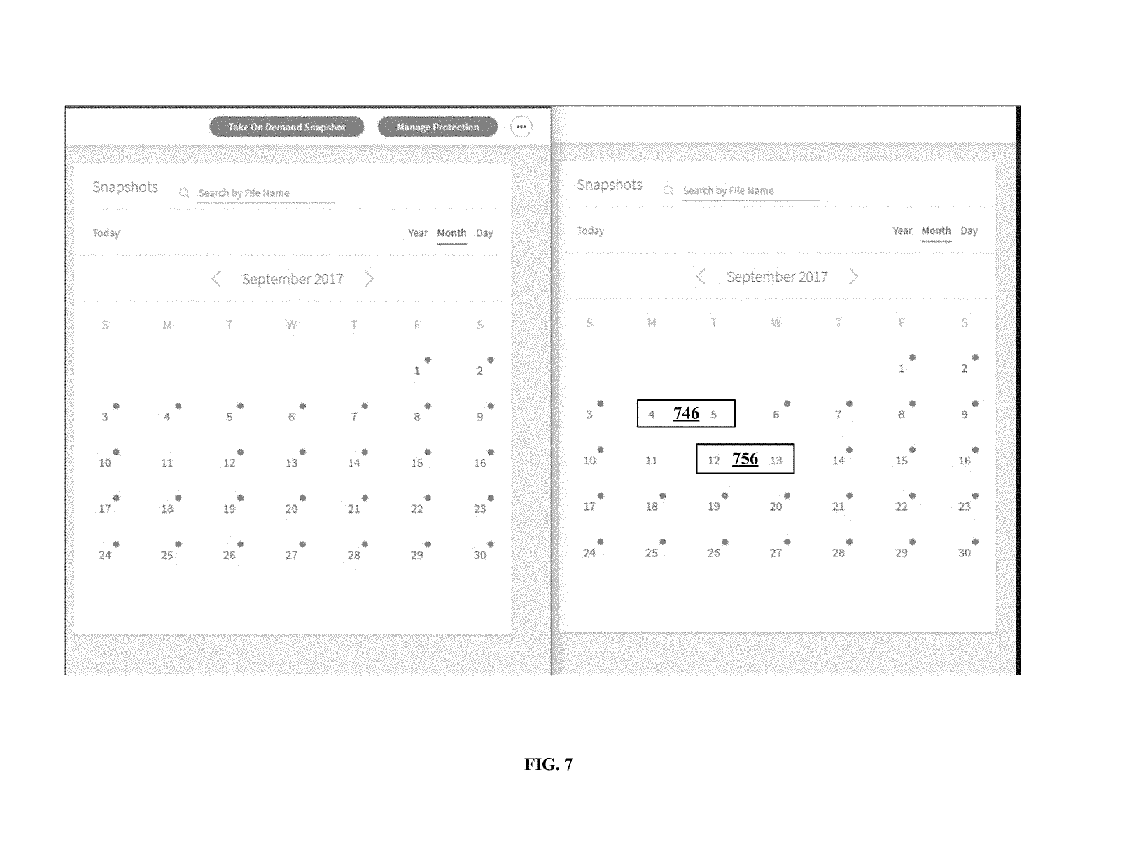

FIG. 7 shows a replication report, with the source cluster snapshots represented by the dots on dates on the left side of the screen, and target cluster snapshots represented by the dots on the right side of the screen. Note that September 4^{th} and September 5^{th} 746 and September 12^{th} and September 13^{th} 756 were skipped in the replication process.

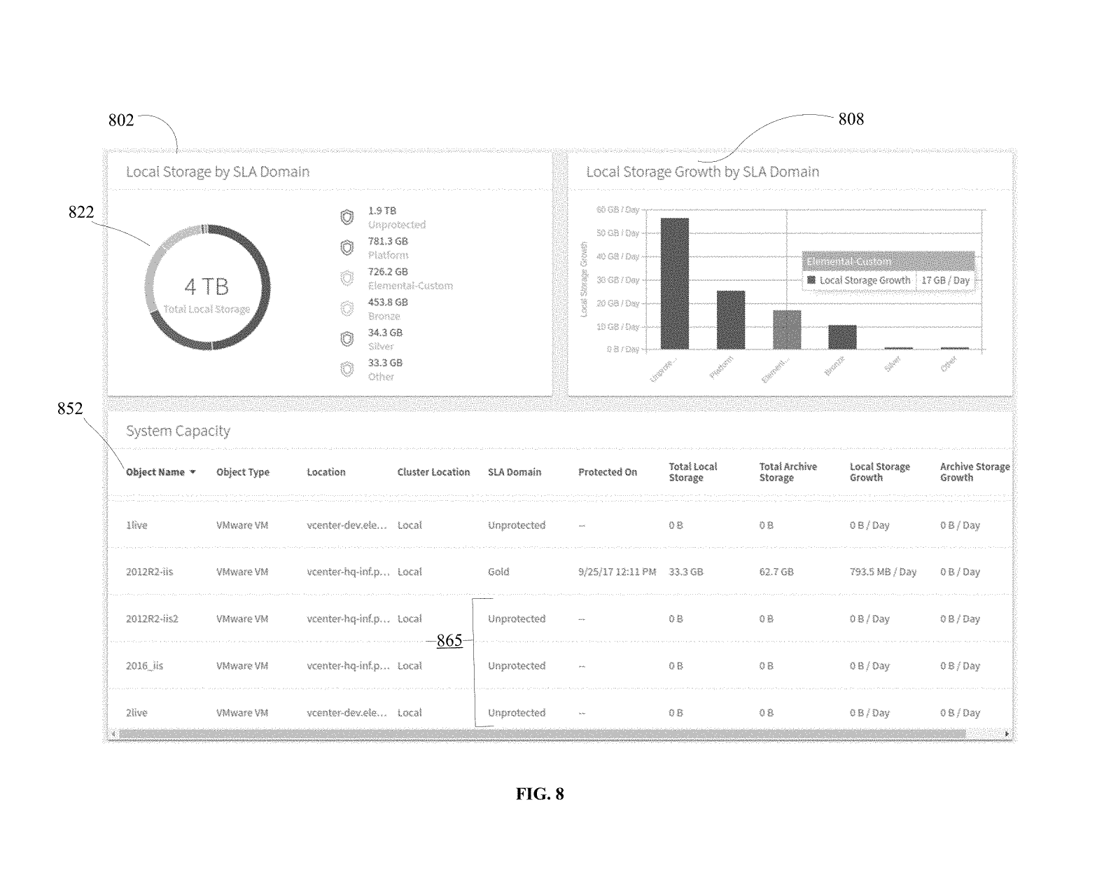

FIG. 8 shows a platform 102 user interface dashboard of a system report that includes local storage by SLA domain 802, local storage growth by SLA domain 808, and a list of VM objects 852 by name, object type, SLA domain and location. The report illustrates the clustered architecture with the file system distributed across the nodes. The UI also makes it possible to view backups taking place, see failures such as a database offline. In the example report of FIG. 8, three VMs are listed as unprotected 865 because they are not associated with a SLA Domain. The total local storage utilized is 4 TB 822. In general, the dashboard is usable for managing VMs and data end to end. When VMs get added, platform 102 monitors the handshake and inventories the added objects. Real time filters support search features and any changes of SLA protection.

Computer System

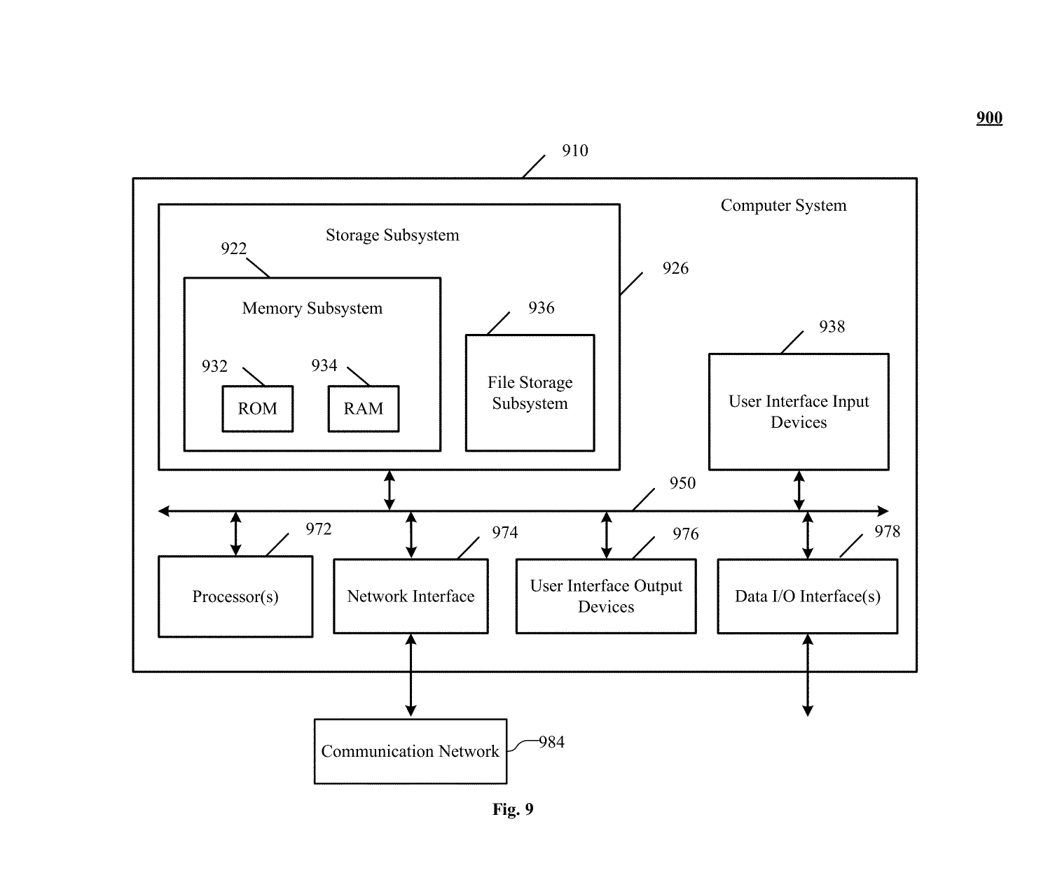

FIG. 9 is a simplified block diagram of an embodiment of a system 900 for replicating to a replication target at a target machine and at a current replication set-point, a set of snapshots including replicated snapshots and un-replicated snapshots, stored in time sequence at a source machine, that create a copy of multiple virtual machines. System 900 can be implemented using a computer program stored in system memory, or stored on other memory and distributed as an article of manufacture, separately from the computer system.

Computer system 910 typically includes a processor subsystem 972 which communicates with a number of peripheral devices via bus subsystem 950. These peripheral devices may include a storage subsystem 926, comprising a memory subsystem 922 and a file storage subsystem 936, user interface input devices 938, user interface output devices 978, and a network interface subsystem 976. The input and output devices allow user interaction with computer system 910 and network and channel emulators. Network interface subsystem 974 provides an interface to outside networks and devices of the system 900. The computer system further includes communication network 984 that can be used to communicate with user equipment (UE) units; for example, as a device under test.

The physical hardware component of network interfaces are sometimes referred to as network interface cards (NICs), although they need not be in the form of cards: for instance they could be in the form of integrated circuits (ICs) and connectors fitted directly onto a motherboard, or in the form of microcells fabricated on a single integrated circuit chip with other components of the computer system.

User interface input devices 938 may include a keyboard, pointing devices such as a mouse, trackball, touchpad, or graphics tablet, a scanner, a touch screen incorporated into the display, audio input devices such as voice recognition systems, microphones, and other types of input devices. In general, use of the term “input device” is intended to include all possible types of devices and ways to input information into computer system 910.

User interface output devices 978 may include a display subsystem, a printer, a fax machine, or non-visual displays such as audio output devices. The display subsystem may include a flat panel device such as a liquid crystal display (LCD) or LED device, a projection device, a cathode ray tube (CRT) or some other mechanism for creating a visible image. The display subsystem may also provide non visual display such as via audio output devices. In general, use of the term “output device” is intended to include all possible types of devices and ways to output information from computer system 910 to the user or to another machine or computer system. The computer system further can include user interface output devices 978 for communication with user equipment.

Storage subsystem 926 stores the basic programming and data constructs that provide the functionality of certain embodiments of the present invention. For example, the various modules implementing the functionality of certain embodiments of the invention may be stored in a storage subsystem 926. These software modules are generally executed by processor subsystem 972.

Storage subsystem 926 typically includes a number of memories including a main random access memory (RAM) 934 for storage of instructions and data during program execution and a read only memory (ROM) 932 in which fixed instructions are stored. File storage subsystem 936 provides persistent storage for program and data files, and may include a hard disk drive, a floppy disk drive along with associated removable media, a CD ROM drive, an optical drive, or removable media cartridges. The databases and modules implementing the functionality of certain embodiments of the invention may have been provided on a computer readable medium such as one or more CD-ROMs, and may be stored by file storage subsystem 936. The host memory storage subsystem 926 contains, among other things, computer instructions which, when executed by the processor subsystem 972, cause the computer system to operate or perform functions as described herein. As used herein, processes and software that are said to run in or on “the host” or “the computer”, execute on the processor subsystem 972 in response to computer instructions and data in the host memory storage subsystem 926 including any other local or remote storage for such instructions and data.

Bus subsystem 950 provides a mechanism for letting the various components and subsystems of computer system 910 communicate with each other as intended. Although bus subsystem 950 is shown schematically as a single bus, alternative embodiments of the bus subsystem may use multiple busses.

Computer system 910 itself can be of varying types including a personal computer, a portable computer, a workstation, a computer terminal, a network computer, a television, a mainframe, or any other data processing system or user device. Due to the ever changing nature of computers and networks, the description of computer system 910 depicted in FIG. 9 is intended only as a specific example for purposes of illustrating embodiments of the present invention. Many other configurations of computer system 910 are possible having more or less components than the computer system depicted in FIG. 9.

Some Particular Implementations

Some particular implementations and features are described in the following discussion.

In one implementation the disclosed technology includes a method of replicating to a replication target at a target machine and at a current replication set-point, a set of snapshots including replicated snapshots and un-replicated snapshots, stored in time sequence at a source machine, that create a copy of multiple virtual machines. The disclosed method includes the source machine receiving a criterion for an un-replicated window, wherein the un-replicated window indicates a difference in the sequence between the current replication set-point and a last replication set-point, the last replication set-point corresponding to at least one un-replicated snapshot after a last replicated snapshot in the sequence; and comparing the un-replicated window to the received criterion for the un-replicated window. Based upon the comparing: when the un-replicated window is greater than the received criterion for an un-replicated window, replicating a snapshot in the sequence equal to or greater than a configured set-point position of the un-replicated window in the sequence, thereby skipping some earlier un-replicated snapshots at positions prior to the configured set-point position, and marking the replicated snapshot in the sequence; and replicating an un-replicated snapshot positioned after the last replicated snapshot in the sequence, otherwise.

This method and other implementations of the technology disclosed can include one or more of the following features and/or features described in connection with additional methods disclosed. In the interest of conciseness, the combinations of features disclosed in this application are not individually enumerated and are not repeated with each base set of features.

In some implementations of the disclosed method, the current set-point is the time of the most recent replication and the last replication set-point is a time when the last replication had taken place.

In some implementations, the configured set-point position is set to greater than fifty percent of the un-replicated window in the sequence.

For some implementations, the disclosed method further includes receiving from a target cluster a replication request, and providing to the target cluster, a response; therein the response includes a snapshot id chosen to replicate and the criterion for this replication set-point.

For one disclosed implementation, the method includes always capturing a first snapshot and a second snapshot in the sequence.

For some implementations of the disclosed method, the criterion is a time period between a first and a last un-replicated snapshot after the last replicated snapshot. In another implementation, the criterion is a count of un-replicated snapshots after the last replicated snapshot. In yet another implementation, the criterion is an amount of data un-replicated in un-replicated snapshots after the last replicated snapshot. In one implementation, the criterion is seven days. In other cases, the criterion can be one month, one year, or four hours.

For some implementations of the disclosed method, the source machine is a physical machine. For some implementations, the target machine is a physical machine.

Another implementation may include a system that includes a target machine having a replication target, and a source machine having a set of snapshots including replicated snapshots and un-replicated snapshots stored in sequence that backup one or more virtual machines. The disclosed source machine includes one or more processors coupled with memory storing instructions that when executed perform at a current replication set-point: receive a criterion for an un-replicated window, wherein the un-replicated window indicates a difference in the sequence between the current replication set-point and a last replication set-point, the last replication set-point corresponding to at least one un-replicated snapshot after a last replicated snapshot in the sequence. The system compares the un-replicated window determined to a previously determined criterion for the un-replicated window, and based upon the comparing: when the un-replicated window is greater than the previously determined criterion for an un-replicated window, replicates a snapshot in the sequence equal to or greater than a configured set-point position of the un-replicated window in the sequence, thereby skipping some earlier un-replicated snapshots at positions prior to the middle position and marking the replicated snapshot in the sequence, and otherwise, replicate an un-replicated snapshot after the last replicated snapshot in the sequence.

This system and other implementations of the technology disclosed can include one or more of the features and/or features described in connection with methods disclosed. In the interest of conciseness, the combinations of features disclosed in this application are not individually enumerated and are not repeated with each base set of features.

Yet another implementation may include a non-transitory computer readable medium storing instructions for replicating to a replication target at a target machine and at a current replication set-point, a set of snapshots including replicated snapshots and un-replicated snapshots stored in sequence at a source machine that backup one or more virtual machines, which instructions, when executed by one or more processors, perform: receiving a criterion for an un-replicated window, wherein the un-replicated window indicates a difference in the sequence between the current replication set-point and a last replication set-point, the last replication set-point corresponding to at least one un-replicated snapshot after a last replicated snapshot in the sequence; and comparing the un-replicated window determined to a previously determined criterion for the un-replicated window. Based upon the comparing: when the un-replicated window is greater than the previously determined criterion for an un-replicated window, replicate a snapshot in the sequence equal to or greater than a configured set-point position of the un-replicated window in the sequence, thereby skipping some earlier un-replicated snapshots at positions prior to the middle position and marking the replicated snapshot in the sequence, and otherwise, replicate an un-replicated snapshot after the last replicated snapshot in the sequence. For purposes of this application, a computer readable medium does not include a transitory wave form.

In some implementations, the disclosed method can include a sequence that is not time-ordered. One disclosed implementation includes a method of replicating to a replication target at a target machine and at a current replication set-point, a set of snapshots including replicated snapshots and un-replicated snapshots, stored in sequence at a source machine, that backup one or more virtual machines, the source machine performing: receiving a criterion for an un-replicated window, wherein the un-replicated window indicates a difference in the sequence between the current replication set-point and a last replication set-point, the last replication set-point corresponding to at least one un-replicated snapshot after a last replicated snapshot in the sequence. The method also includes comparing the un-replicated window determined to a previously determined criterion for the un-replicated window, and based upon the comparing: when the un-replicated window is greater than the received criterion for an un-replicated window, replicating a snapshot in the sequence equal to or greater than a configured set-point position of the un-replicated window in the sequence, thereby skipping some earlier un-replicated snapshots at positions prior to the configured set-point position, and marking the replicated snapshot in the sequence; and replicating an un-replicated snapshot positioned after the last replicated snapshot in the sequence, otherwise.

For some implementations of the disclosed method, the current set-point is a current time and the last replication set-point is a time when the last replication had taken place. Some implementations of the disclosed method further include always capturing a first snapshot and a second snapshot in the sequence. In some implementations of the disclosed method, the criterion is a count of un-replicated snapshots after the last replicated snapshot. In other cases, the criterion is an amount of data un-replicated in un-replicated snapshots after the last replicated snapshot.

While the technology disclosed is disclosed by reference to the preferred embodiments and examples detailed above, it is to be understood that these examples are intended in an illustrative rather than in a limiting sense. It is contemplated that modifications and combinations will readily occur to those skilled in the art, which modifications and combinations will be within the spirit of the innovation and the scope of the following claims.

We claim as follows:

1. A method of replicating to a replication target at a target machine and at a current replication set-point, a set of snapshots including replicated snapshots and un-replicated snapshots, stored in time sequence at a source machine, that create a copy of multiple virtual machines, the source machine:
receiving a criterion for an un-replicated window, wherein the un-replicated window indicates a difference in the sequence between the current replication set-point and a last replication set-point, the last replication set-point corresponding to at least one un-replicated snapshot after a last replicated snapshot in the sequence; and
comparing the un-replicated window to the received criterion for the un-replicated window, and based upon the comparing:
when the un-replicated window is greater than the received criterion for an un-replicated window,
replicating a snapshot in the sequence equal to or greater than a configured set-point position of the un-replicated window in the sequence, thereby skipping some earlier un-replicated snapshots at positions prior to the configured set-point position, and
marking the replicated snapshot in the sequence; and
replicating an un-replicated snapshot positioned after the last replicated snapshot in the sequence, otherwise.

2. The method of claim 1, wherein the current set-point is the time of the most recent replication and the last replication set-point is a time when the last replication had taken place.

3. The method of claim 1, wherein the configured set-point position is set to greater than fifty percent of the un-replicated window in the sequence.

4. The method of claim 1, wherein the criterion is a time period between a first and a last un-replicated snapshot after the last replicated snapshot.

5. The method of claim 1, further including receiving from a target cluster a replication request, and providing to the target cluster, a response; and therein the response includes a snapshot id chosen to replicate and the criterion for this replication set-point.

6. The method of claim 1, further including always capturing a first snapshot and a second snapshot in the sequence.

7. The method of claim 1, wherein the criterion is a count of un-replicated snapshots after the last replicated snapshot.

8. The method of claim 1, wherein the criterion is an amount of data un-replicated in un-replicated snapshots after the last replicated snapshot.

9. The method of claim 1, wherein the source machine is a physical machine.

10. The method of claim 1, wherein the target machine is a physical machine.

11. A system including:
a target machine having a replication target;
a source machine having a set of snapshots including replicated snapshots and un-replicated snapshots stored in time sequence that backup one or more virtual machines,
the source machine including one or more processors coupled with memory storing instructions that when executed perform at a current replication set-point:
receiving a criterion for an un-replicated window, wherein the un-replicated window indicates a difference in the sequence between the current replication set-point and a last replication set-point, the last replication set-point corresponding to at least one un-replicated snapshot after a last replicated snapshot in the sequence; and
comparing the un-replicated window determined to a previously determined criterion for the un-replicated window, and based upon the comparing:
when the un-replicated window is greater than the previously determined criterion for an un-replicated window, replicate a snapshot in the sequence equal to or greater than a configured set-point position of the un-replicated window in the sequence, thereby skipping some earlier un-replicated snapshots at positions prior to the middle position and marking the replicated snapshot in the sequence, and
otherwise, replicate an un-replicated snapshot after the last replicated snapshot in the sequence.

12. The system of claim 11, wherein the current replication set-point is the time of the most recent replication and the last replication set-point is a time when the last replication had taken place.

13. The system of claim 11, wherein the criterion is a time period.

14. The system of claim 11, further including receiving from a target cluster a replication request, and providing to the target cluster, a response; and therein the response includes a snapshot id chosen to replicate and the criterion for this replication set-point.

15. The system of claim 11, further including always capturing a first snapshot and a second snapshot in the sequence.

16. The system of claim 11, wherein the criterion is a count of un-replicated snapshots after the last replicated snapshot.

17. The system of claim 11, wherein the criterion is an amount of data un-replicated in un-replicated snapshots after the last replicated snapshot.

18. The system of claim 11, wherein the source machine is a physical machine.

19. The system of claim 11, wherein the target machine is a physical machine.

20. A non-transitory computer readable medium storing instructions for replicating to a replication target at a target machine and at a current replication set-point, a set of snapshots including replicated snapshots and un-replicated snapshots stored in sequence at a source machine that backup one or more virtual machines, which instructions, when executed by one or more processors, perform:
receiving a criterion for an un-replicated window, wherein the un-replicated window indicates a difference in the sequence between the current replication set-point and a last replication set-point, the last replication set-point corresponding to at least one un-replicated snapshot after a last replicated snapshot in the sequence; and
comparing the un-replicated window determined to a previously determined criterion for the un-replicated window, and based upon the comparing:
when the un-replicated window is greater than the previously determined criterion for an un-replicated window, replicate a snapshot in the sequence equal to or greater than a configured set-point position of the un-replicated window in the sequence, thereby skipping some earlier un-replicated snapshots at positions prior to the middle position and marking the replicated snapshot in the sequence, and
otherwise, replicate an un-replicated snapshot after the last replicated snapshot in the sequence.

21. A method of replicating to a replication target at a target machine and at a current replication set-point, a set of snapshots including replicated snapshots and un-replicated snapshots, stored in sequence at a source machine, that backup one or more virtual machines, the source machine performing:
receiving a criterion for an un-replicated window, wherein the un-replicated window indicates a difference in the sequence between the current replication set-point and a last replication set-point, the last replication set-point corresponding to at least one un-replicated snapshot after a last replicated snapshot in the sequence; and
comparing the un-replicated window determined to a previously determined criterion for the un-replicated window, and based upon the comparing:
when the un-replicated window is greater than the received criterion for an un-replicated window,
replicating a snapshot in the sequence equal to or greater than a configured set-point position of the un-replicated window in the sequence, thereby skipping some earlier un-replicated snapshots at positions prior to the configured set-point position, and
marking the replicated snapshot in the sequence; and
replicating an un-replicated snapshot positioned after the last replicated snapshot in the sequence, otherwise.

22. The method of claim 21, wherein the current set-point is a current time and the last replication set-point is a time when the last replication had taken place.

23. The method of claim 21, further including always capturing a first snapshot and a second snapshot in the sequence.

24. The method of claim 21, wherein the criterion is a count of un-replicated snapshots after the last replicated snapshot.

25. The method of claim 21, wherein the criterion is an amount of data un-replicated in un-replicated snapshots after the last replicated snapshot.
